(19) United States
(12) Patent Application Publication
(10) Pub. No.: US 2020/0044325 A1
(43) Pub. Date: Feb. 6, 2020

(54) ANTENNA TILTING ASSEMBLY

(71) Applicant: James Stevens, Riverside, CA (US)

(72) Inventor: James Stevens, Riverside, CA (US)

(21) Appl. No.: 16/055,718

(22) Filed: Aug. 6, 2018

(51) Int. Cl. H01Q 1/32; H01Q 1/12

(52) U.S. Cl. CPC H01Q 1/3275; H01Q 1/1221

(57) ABSTRACT

An antenna tilting assembly for mounting a CB antenna at an angle on a vehicle includes a citizen's band (CB) antenna. A mount is included that is mounted on a vehicle and the mount is positioned on an exterior of the vehicle. A fitting is provided that has a first section forming an angle with respect to a second section. The fitting is removably coupled between the CB antenna and the mount. Thus, the CB antenna is oriented at an angle corresponding to the angle between the first and second sections. In this way the fitting enhances an ornamental appearance of the CB antenna.

### CROSS-REFERENCE TO RELATED APPLICATIONS

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to tilting devices and more particularly pertains to a new tilting device for mounting a CB antenna at an angle on a vehicle.

### BRIEF SUMMARY OF THE INVENTION

An embodiment of the disclosure meets the needs presented above by generally comprising a citizen's band (CB) antenna. A mount is included that is mounted on a vehicle and the mount is positioned on an exterior of the vehicle. A fitting is provided that has a first section forming an angle with respect to a second section. The fitting is removably coupled between the CB antenna and the mount. Thus, the CB antenna is oriented at an angle corresponding to the angle between the first and second sections. In this way the fitting enhances an ornamental appearance of the CB antenna.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a fitting of an antenna tilting assembly according to an embodiment of the disclosure.

FIG. 2 is a top view of a fitting of an embodiment of the disclosure.

FIG. 3 is a back view of a fitting of an embodiment of the disclosure.

FIG. 4 is a front view of a fitting of an embodiment of the disclosure.

FIG. 5 is a right side phantom view of a fitting of an embodiment of the disclosure.

FIG. 6 is a perspective in-use view of an embodiment of the disclosure.

### DETAILED DESCRIPTION OF THE INVENTION

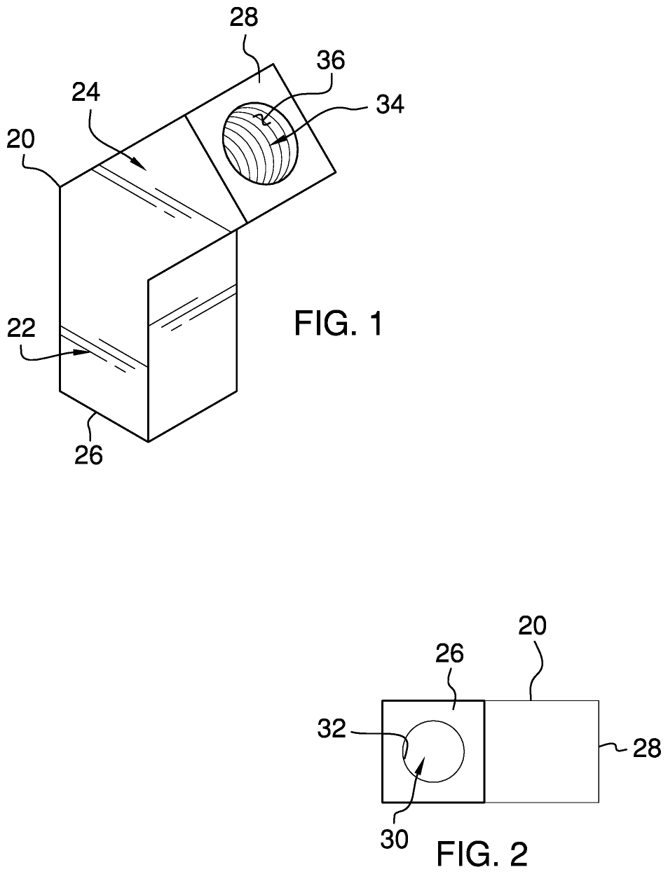

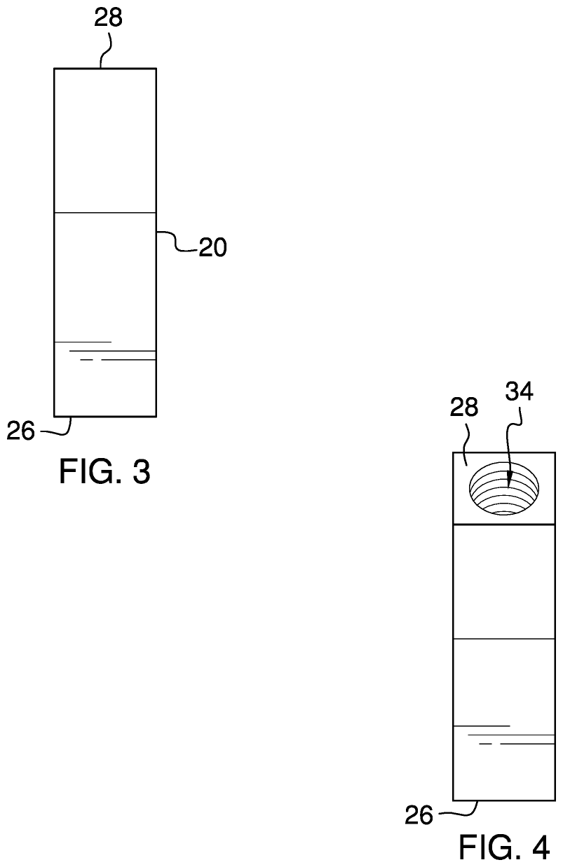

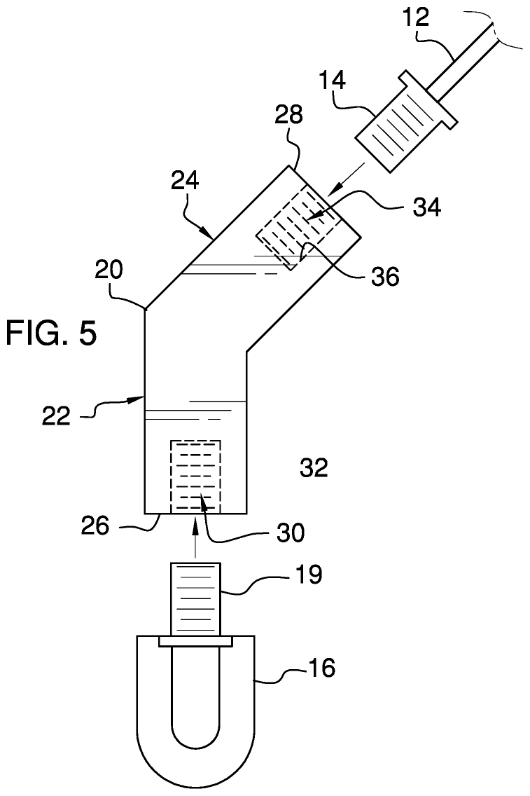

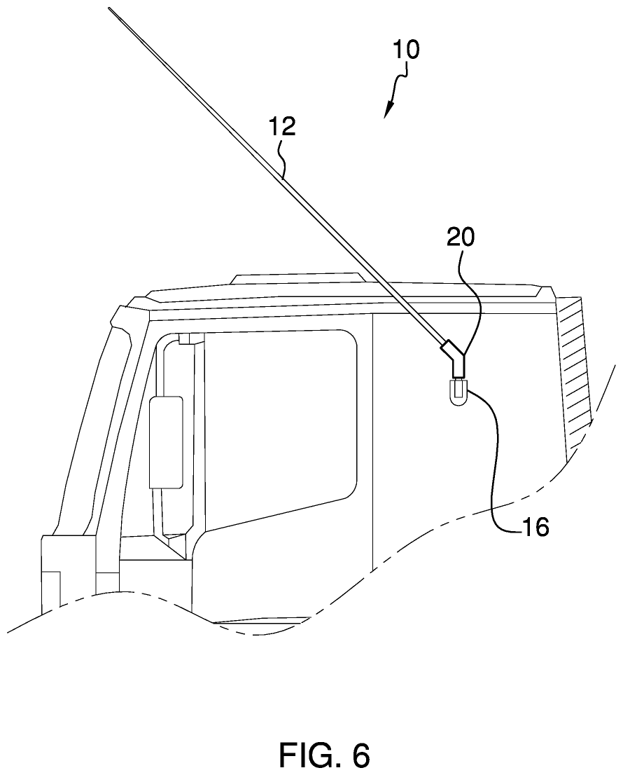

With reference now to the drawings, and in particular to FIGS. 1 through 6 thereof, a new tilting device embodying the principles and concepts of an embodiment of the disclosure and generally designated by the reference numeral 10 will be described.

As best illustrated in FIGS. 1 through 6, the antenna tilting assembly 10 generally comprises a citizen's band (CB) antenna 12 that has an output port 14. The CB antenna 12 may be a CB antenna of any conventional size and length, including but not being limited to, CB antennas commonly used on semi tractors. A mount 16 is included and the mount 16 is mounted on a vehicle 18. The mount 16 is positioned on an exterior of the vehicle 18 and the mount 16 includes a screw 19. The mount 16 may be a CB antenna mount of any conventional design, including but not being limited to, CB antenna mounts commonly fitted on rear view mirrors of semi tractors. Moreover, the vehicle 18 may be a semi tractor or any other motorized vehicle.

A fitting 20 is included that has a first section 22 forming an angle with respect to a second section 24. The angle formed by the first 22 and second 24 sections may range between approximately 35.0 degrees and 45.0 degrees. Additionally, each of the first 22 and second 24 sections may have a length of approximately 2.0 inches. The fitting 20 is removably coupled between the CB antenna 12 and the mount 16 such that the CB antenna 12 is oriented at an angle corresponding to the angle between the first 22 and second 24 sections. In this way the fitting 20 enhances an ornamental appearance of the CB antenna 12 by orienting the CB antenna 12 at a customized angle on the vehicle 18.

The fitting 20 has a first end 26 and a second end 28, the first end 26 is associated with the first section 22 and the second end 28 is associated with the second section 24. The first end 26 has a first well 30 extending inwardly therein, the first well 30 has a bounding surface 32 and the bounding surface 32 is threaded. The first well 30 insertably receives the screw 19 on the mount 16 having the screw 19 threadably engaging the bounding surface 32. The second end 28 has a second well 34 extending inwardly therein, the second well 34 has a bounding surface 36 and the bounding surface 36 of the second well 34 is threaded. The second well 34 insertably receives the output port 14 on the CB antenna 12 having the output port 14 threadably engages the bounding surface 36 of the second well 34.

In use, the first end 26 of the fitting 20 is threaded onto the screw 19 on the mount 16. Additionally, the fitting 20 is oriented on the mount 16 such that the second section 24 of the fitting 20 angles in a selected direction with respect to the vehicle 18. The output port 14 of the CB antenna 12 is threaded into the second end 28 of the fitting 20. In this way the CB antenna 12 is coupled to the mount 16 at a customized angle for improving the appearance of one or more CB antennas 12 on the vehicle 18. Additionally, the fitting 20 facilitates existing CB antennas 12 to be mounted at the customized angle without requiring modifications to the existing mount 16 or the vehicle 18.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. An antenna tilting assembly for positioning an antenna at an angle on a vehicle, said assembly comprising:
a citizen's band (CB) antenna;
a mount being mounted on a vehicle, said mount being positioned on an exterior of said vehicle;
a fitting having a first section forming an angle with respect to a second section, said fitting being removably coupled between said CB antenna and said mount such that said CB antenna is oriented at an angle corresponding to said angle between said first and second sections wherein said fitting is configured to enhance an ornamental appearance of said CB antenna.

2. The assembly according to claim 1, wherein:
said fitting has a first end and a second end, said first section having said first end being associated therewith, said second section having said second end being associated therewith;
said first end has a first well extending inwardly therein, said first well having a bounding surface, said bounding surface being threaded; and
said second end has a second well extending inwardly therein, said second well having a bounding surface, said bounding surface of said second well being threaded.

3. The assembly according to claim 2, wherein:
said mount includes a screw; and
said first well insertably receives said screw on said mount having said screw threadably engaging said bounding surface.

4. The assembly according to claim 2, wherein:
said CB antenna has an output port; and
said second well insertably receives said output port on said CB antenna having said output port threadably engaging said bounding surface of said second well.

5. An antenna tilting assembly for positioning an antenna at an angle on a vehicle, said assembly comprising:
a citizen's band (CB) antenna having an output port;
a mount being mounted on a vehicle, said mount being positioned on an exterior of said vehicle, said mount including a screw; and
a fitting having a first section forming an angle with respect to a second section, said fitting being removably coupled between said CB antenna and said mount such that said CB antenna is oriented at an angle corresponding to said angle between said first and second sections wherein said fitting is configured to enhance an ornamental appearance of said CB antenna, said fitting having a first end and a second end, said first section having said first end being associated therewith, said second section having said second end being associated therewith, said first end having a first well extending inwardly therein, said first well having a bounding surface, said bounding surface being threaded, said first well insertably receiving said screw on said mount having said screw threadably engaging said bounding surface, said second end having a second well extending inwardly therein, said second well having a bounding surface, said bounding surface of said second well being threaded, said second well insertably receiving said output port on said CB antenna having said output port threadably engaging said bounding surface of said second well.
